(19) United States
(12) Patent Application Publication
(10) Pub. No.: US 2011/0306454 A1
(43) Pub. Date: Dec. 15, 2011

(54) SPROCKET CHAIN

(75) Inventors: Klaus Hahn, Fuerth-Burgfarrnbach (DE); Bolko Schuseil, Adelsdorf (DE)

(73) Assignee: SCHAEFFLER TECHNOLOGIES GMBH & CO. KG, (DE)

(21) Appl. No.: 13/201,975

(22) PCT Filed: Feb. 12, 2010
(86) PCT No.: PCT/EP2010/051768

§ 371 Date: Aug. 17, 2011

(30) Foreign Application Priority Data
Feb. 18, 2009 (DE) 10 2009 009 369.9

(51) Int. Cl. F16G 13/02

(52) U.S. Cl. 474/219

(57) ABSTRACT

A sprocket chain formed by several pivotally interconnected chain links that have at least one central plate and at least two cover plates which are arranged on both sides of the central plate. The cover plates and the central plate are interconnected using at least two connecting members. The chain links also have at least two inner plates which are arranged between the cover plates and the central plate and pivotally interconnect the chain links. The total width of a bunch of plates formed by the central plate, the cover plates, and the inner plates, divided by the total number of plates, which is formed by the sum of the central plate, the cover plates, and the inner plates, is greater than or equal to 1.4 mm.

### FIELD OF THE INVENTION

The invention relates to a toothed chain formed by a plurality of chain links pivotably connected to one another, having at least one central link plate and at least two cover link plates arranged at both sides of the central link plate, the cover link plates and the central link plate being connected to one another by means of at least two connecting members, and having at least two inner link plates arranged between the cover link plates and the central link plate, which inner link plates pivotably connect the chain links to one another.

Toothed chains of said type are frequently used in motor vehicles and serve there as a timing and assembly drive in the internal combustion engine. In one application, the toothed chain is wrapped around the crankshaft, which in this case is the driving shaft, and around at least one camshaft or a camshaft adjuster, which in this case is the driven shaft, and thereby transmits the rotational movement of the crankshaft to the camshaft. For the transmission of the rotational movement, in particular the inner lugs have tooth-like inwardly and/or outwardly directed projections which engage into corresponding receptacles of the drive pulleys of the driving and driven shafts. The central link plates are connected to the connecting members, which are designed preferably as pins, for conjoint rotation therewith and serve for the transmission of tensile force within the chain links. The cover link plates are arranged at both sides of the central link plates and laterally cover the link plate packs formed by the central link plates and the inner link plates. The central link plates together with the cover link plates and the connecting members form the chain links of the toothed chain.

The inner link plates are arranged between the central link plates and the cover link plates and connect the chain links to one another. Here, the inner link plates are pivotably held with play on the connecting members. On account of the pivotable arrangement of the inner link plates, the toothed chain is flexible and can adapt to different profiles between the driving and driven shafts.

In order that the toothed chain can perform its function, it is accordingly necessary for various link plates of different function to be provided which, when combined to form a link plate pack, must have a certain width. The predefined width of the link plate pack is determined by the intended guidance of the toothed chain and by a certain force distribution, such that the maximum loading of the toothed chain does not exceed a certain value. A further aspect to be taken into consideration in the design is the number of individual link plates, because the assembly expenditure and the associated costs increase with the number of individual link plates.

It is an object of the invention to provide a toothed chain which has the required width while having the lowest possible number of individual link plates.

The object is achieved by means of a toothed chain having the features of claim 1. Advantageous refinements of the invention will emerge from the subclaims.

It is proposed according to the invention that the total width of the link plate pack, formed by the central link plate, the cover link plates and the inner link plates, divided by the total number of individual link plates, formed from the sum of the central link plate, the cover link plates and the inner link plates, is greater than or equal to 1.4 mm. By means of the ratio proposed according to the invention for the total width of the link plate pack to the number of individual link plates, it is possible for the required width to be realized with the lowest possible number of individual link plates. By means of the proposed ratio, the toothed chain meets both the requirements for strength and also the requirements with regard to the guidance and the mobility of the toothed chain, and can nevertheless be produced with very low production costs.

It has also been found that the width of a cover link plate divided by the width of the central link plate should be less than or equal to 0.6. By means of the proposed ratio, the cover link plate and the central link plate may be dimensioned such that they can each optimally perform their functions. The cover link plates serve substantially to laterally cover and hold together the link plate packs, and accordingly need not accommodate high tensile forces, such that the proposed thickness in relation to the central link plate is entirely adequate. The central link plate, in contrast, has the task of transmitting tensile forces and is accordingly dimensioned so as to be thicker, such that the maximum stress in the central link plate does not exceed a predefined value. Overall, by means of the proposed ratio, the degree of material utilization both of the central link plate and also of the cover link plate is increased, without the maximum loading limits being exceeded in the process.

It is also proposed that the width of the central link plate be greater than the width of the inner link plates, and the width of the inner link plates be greater than the width of the cover link plates. The central link plate thereby has the greatest load-bearing capacity whereas the inner link plates are of smaller dimensions, which is acceptable because, in the case of the inner link plates, the tensile force is distributed between at least two inner link plates. The cover link plates are designed to be even thinner than the inner link plates because said cover link plates, in terms of their main purpose, specifically do not transmit any tensile forces.

It has also been found that the link plates can each optimally perform their function if the central link plate has a thickness of 2.0 to 2.5 mm, the inner link plates have a thickness of 1.5 to 2.0 mm and the cover link plates have a thickness of 0.8 to 1.0 mm.

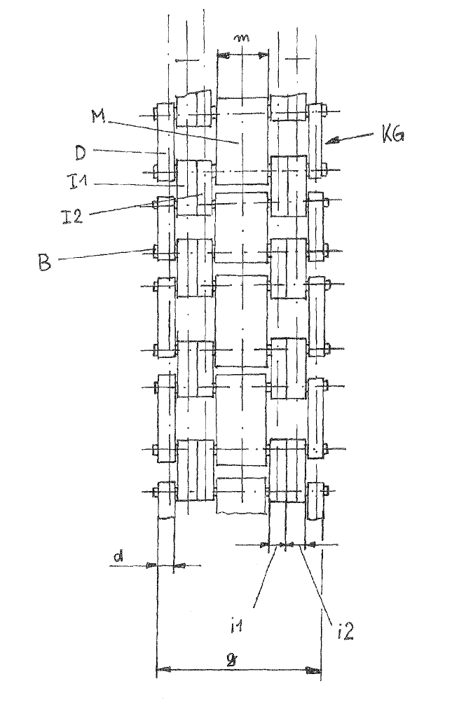

The invention will be explained in more detail below on the basis of the single FIG. 1.

FIG. 1 shows a plan view toothed chain according to the invention.

FIG. 1 shows a toothed chain which is assembled from a plurality of chain links KG. Each chain link KG is formed from a central link plate M, two cover link plates D which cover the chain links KG at the edge, and two connecting members B formed as pins. The central link plates M are connected to the connecting members B for conjoint rotation therewith and have the task of accommodating the tensile forces acting within the chain links KG. For this purpose, the central link plates M are preferably pressed together with the connecting members B such that the latter are additionally secured so as to be prevented from sliding laterally. Furthermore, in each case two inner link plates I1 and I2 are pivotably held on the connecting members B at. both sides of the central link plates M, which inner link plates I1 and I2 connect the chain links KG to one another. On account of the pivotability of the inner link plates I1 and I2, the chain links KG are likewise pivotable relative to one another, such that the toothed chain as a whole can adapt to different profiles between the driving and driven shafts.

The total width g of the toothed chain or of the link plate pack is formed by the sum of the width m of the central link plate M, the twofold sum of the widths i1 and i2 of the inner link plates I1 and I2, and the sum of the widths d of the two cover link plates D. The slight lateral projecting length of the connecting members B is not taken into consideration in the determination of the total width g because it is not of significance for the toothed chain design according to the invention. In the exemplary embodiment illustrated, the width m of the central link plate M is 2.3 mm, the widths i1 and i2 of the inner link plates I1 and I2 are in each case 1.5 mm, and the width d of the cover link plates D is 0.9 mm. Overall, this results in a total width g of the link plate pack of 10.1 mm. With a number of seven individual link plates, this therefore yields a ratio of 1.44 mm.

Also alternatively conceivable would be a toothed chain with only two inner link plates which have a width of 2 mm, such that with an unchanged width m of the central link plate M of 2.3 mm and a width d of the cover link plates D of 0.9 mm, a total width of 8.1 mm would be obtained with a number of five individual link plates and a ratio of 1.62.

Overall, the central link plate M is accordingly the widest individual link plate and accommodates the greatest tensile forces, whereas at least two inner link plates I1 and I2 are provided, such that these, despite the high tensile forces to be transmitted, can be designed to be slightly thinner. Finally, the cover link plates D are the thinnest individual link plates because their actual task is not that of transmitting tensile forces but rather that of laterally covering the chain links and ensuring that the link plate packs are held together.

1-4. (canceled)

5. A toothed chain formed by a plurality of chain links pivotably connected to one another, comprising:
at least one central link plate;
at least two cover link plates arranged at both sides of the central link plate;
at least two inner link plates arranged between the cover link plates and the central link plate, the inner link plates pivotably connecting the chain links to one another; and
connecting members connecting the cover link plates and the central link plate to one another,
wherein a total width of a link plate pack, formed by the central link plate, the cover link plates and the inner link plates, divided by a total number of individual link plates, formed from the sum of the central link plate, the cover link plates and the inner link plates, is greater than or equal to 1.4 mm.

6. The toothed chain as claimed in claim 5, wherein a width of a cover link plate divided by a width of the central link plate is less than or equal to 0.6.

7. The toothed chain as claimed in claim 5, wherein a width of the central link plate is greater than a width of the inner link plates, and the width of the inner link plates is greater than a width of the cover link plates.

8. The toothed chain as claimed in claim 5, wherein the central link plate has a thickness of 2.0 to 2.5 mm, the inner link plates have a thickness of 1.5 to 2.0 mm, and the cover link plates have a thickness of 0.8 to 1.0 mm.
